(19) United States
(12) Patent Application Publication
(10) Pub. No.: US 2020/0273153 A1
(43) Pub. Date: Aug. 27, 2020

(54) SURROUNDINGS MONITORING APPARATUS

(71) Applicant: AISIN SEIKI KABUSHIKI KAISHA, Kariya-shi (JP)

(72) Inventor: Takashi HIRAMAKI, Kariya-shi (JP)

(73) Assignee: AISIN SEIKI KABUSHIKI KAISHA, Kariya-shi (JP)

(21) Appl. No.: 16/775,396

(22) Filed: Jan. 29, 2020

(30) Foreign Application Priority Data
Feb. 26, 2019 (JP) 2019-033262

(51) Int. Cl. G06T 5/00; H04N 7/18; B60R 1/00

(52) U.S. Cl. CPC G06T 5/005; H04N 7/18; B60R 11/04; G06T 2207/30252; B60R 1/00

(57) ABSTRACT

A surroundings monitoring apparatus includes an acquisition portion acquiring a captured image captured by an imaging device while a vehicle is moving, the imaging device being mounted at the vehicle to capture an image of surroundings of the vehicle, a restoration processing portion generating a restoration image in a case where a stain exists in the captured image, the restoration image being obtained by restoring an area that is hidden by the stain in the captured image to a state being inhibited from having the stain, and a display determination portion allowing a display of the restoration image until a non-display condition is satisfied, the non-display condition inhibiting the restoration image from being displayed as an image presently indicating the surroundings of the vehicle.

### CROSS REFERENCE TO RELATED APPLICATIONS

This application is based on and claims priority under 35 U.S.C. § 119 to Japanese Patent Application 2019-033262, filed on Feb. 26, 2019, the entire content of which is incorporated herein by reference.

### TECHNICAL FIELD

This disclosure generally relates to a surroundings monitoring apparatus.

### BACKGROUND DISCUSSION

A known system causes a driver of a vehicle, for example, to recognize surroundings of the vehicle by displaying a captured image at a display device, the captured image being obtained from captured image data captured by an imaging device (i.e., a camera) mounted at the vehicle. In a case where stains such as dust, splashes of mud, and raindrops, for example, are adhered to an imaging surface (for example, a lens) of the imaging device in the aforementioned system, such stains may be included (captured) in the captured image to inhibit appropriate image display for recognition of the surroundings of the vehicle. To overcome the aforementioned circumstances, image processing is performed on the captured image to generate and display a restoration image where such stains are seemingly or apparently removed. The restoration image is displayed and provided to a user of the vehicle so that the user may be able to keep confirming the surroundings of the vehicle by visually checking the restoration image at the display device at an inside the vehicle without cleaning the imaging device by getting out of the vehicle each time the stains are adhered to the lens. Such system is disclosed in JP2017-92622A, for example.

The aforementioned restoration image is a synthetic image generated by eliminating stains in the captured image using image processing. An image that possibly corresponds to an area hidden by the stains in the captured image is superimposed on the aforementioned area. In a case where an object is present at such area hidden by the stains at some instant, the object may fail to be restored and recognized by the user. The restoration image used (i.e., displayed) for a long time period may decrease reliability as a peripheral (surroundings) image accordingly.

A need thus exists for a surroundings monitoring apparatus which is not susceptible to the drawback mentioned above.

### SUMMARY

According to an aspect of this disclosure, a surroundings monitoring apparatus includes an acquisition portion acquiring a captured image captured by an imaging device while a vehicle is moving, the imaging device being mounted at the vehicle to capture an image of surroundings of the vehicle, a restoration processing portion generating a restoration image in a case where a stain exists in the captured image, the restoration image being obtained by restoring an area that is hidden by the stain in the captured image to a state being inhibited from having the stain, and a display determination portion allowing a display of the restoration image until a non-display condition is satisfied, the non-display condition inhibiting the restoration image from being displayed as an image presently indicating the surroundings of the vehicle.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a plan view of a vehicle at which a surroundings monitoring apparatus according to an embodiment is mounted;

FIG. 2 is a block diagram illustrating a configuration of a vehicle control system including the surroundings monitoring apparatus according to the embodiment;

FIG. 3 is a block diagram illustrating a configuration of the surroundings monitoring apparatus according to the embodiment in a case where the surroundings monitoring apparatus (specifically, a surroundings monitoring portion) is achieved by a CPU;

FIG. 4 is an explanatory view schematically illustrating a training image of a stain pre-trained model in the surroundings monitoring apparatus according to the present embodiment;

FIG. 5 is an explanatory view schematically illustrating a restoration processing that generates a restoration image in the surroundings monitoring apparatus according to the present embodiment;

FIG. 6 is an explanatory view schematically illustrating the restoration image and a message indicating that the restoration image is presently displayed (display notification) in the surroundings monitoring apparatus according to the present embodiment;

FIG. 7 is an explanatory view schematically illustrating a non-restoration image and a message indicating that the restoration image is not presently displayed (non-display notification) in the surroundings monitoring apparatus according to the present embodiment; and

FIG. 8 is a flowchart of processing for displaying the restoration image in the surroundings monitoring apparatus according to the present embodiment.

### DETAILED DESCRIPTION

An embodiment disclosed here is explained with reference to the attached drawings. Configurations of the embodiment described below, and operations, results, and effects brought about by such configurations are examples. The embodiment is achievable by other configurations than the following configurations and at least one of various effects based on the basic configuration and derived effects may be obtained.

A surroundings monitoring apparatus according to the embodiment generates a restoration image in a case where a stain is adhered to a lens of an imaging device mounted at a vehicle so that the stain is captured in a captured image. The restoration image corresponds to an image where such stain is seemingly or apparently removed, i.e., an image where the stain does not exist. The surroundings monitoring apparatus includes an improved surroundings monitoring function using the restoration image. In the embodiment, the restoration image is displayed for a limited time period as an emergency procedure until a non-display condition (which prohibits the display of the restoration image) is satisfied and is avoidable from being continuously displayed with no restriction. Maintaining convenience achieved by using the restoration image, i.e., keeping monitoring the surroundings of the vehicle without cleaning the stain each time the stain is adhered to the lens, for example, and ensuring reliability of the system by avoiding the restoration image from being continuously displayed for a long time period are well-balanced. Details of the surroundings monitoring apparatus of the embodiment are explained below.

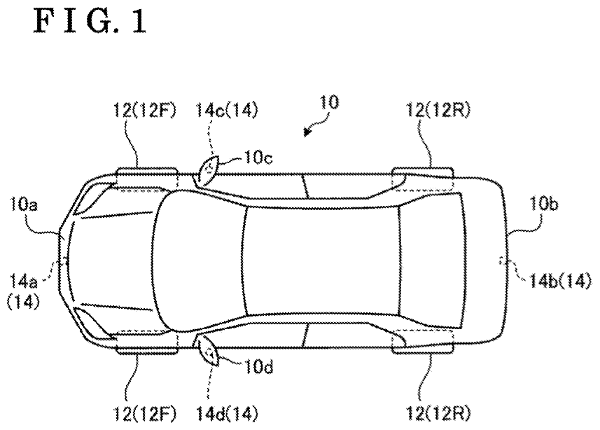

A vehicle 10 illustrated in FIG. 1 may be an automobile including an internal combustion engine (engine) as a driving source (i.e., an internal combustion engine automobile), an automobile including an electric motor (motor) as a driving source (i.e., an electric automobile and a fuel cell automobile, for example), an automobile including both the engine and the motor as a driving source (i.e., a hybrid automobile), or an automobile including the other driving source. The vehicle 10 may include any types of transmission devices and any types of devices including systems and components, for example, for driving the internal combustion engine or the electric motor. A system, the number, and a layout, for example, of a device related to driving of wheels 12 (front wheels 12F and rear wheels 12R) of the vehicle 10 may be appropriately employed or specified.

As illustrated in FIG. 1, the vehicle 10 includes plural imaging devices 14, for example, four imaging devices 14a, 14b, 14c, and 14d. Each of the imaging devices 14 is a digital camera incorporating an imaging element such as a charge coupled device (CCD) and a CMOS image sensor (CIS), for example. The imaging device 14 may output moving image data (captured image data) at a predetermined frame rate. The imaging device 14 has a wide-angle lens or a fisheye lens and may photograph a range of, for example, 140° to 220° in a horizontal direction. An optical axis of the imaging device 14 (14a to 14d) arranged at an outer peripheral portion of the vehicle 10 may be possibly set obliquely downward. The imaging device 14 (14a to 14d) thus sequentially captures images of peripheral environment (circumstances) outside the vehicle 10 including a road surface on which the vehicle 10 is movable, any marks attached on the road surface (an arrow, a compartment line, a parking frame indicating a parking space, and a lane separator, for example), and an object (i.e., an obstacle such as a pedestrian and other vehicles, for example) and outputs the aforementioned images as captured image data.

The imaging device 14a is positioned at a front side of the vehicle body 10, i.e., at a front end portion of the vehicle 10 in a front-rear direction and at a substantially center in a vehicle width direction. The imaging device 14a is provided at a front bumper 10a or a front grill, for example, to capture an image of a front region including the front end portion of the vehicle 10 (for example, the front bumper 10a). The imaging device 14b is positioned at a rear side of the vehicle 10, i.e., at a rear end portion of the vehicle 10 in the front-rear direction and at a substantially center in the vehicle width direction. The imaging device 14b is provided at an upper side of a rear bumper 10b, for example, to capture an image of a rear region including the rear end portion of the vehicle 10 (for example, the rear bumper 10b). The imaging device 14c is positioned at a right-end portion of the vehicle 10, i.e., at a right-side door mirror 10c, for example, to capture an image of a right lateral region (for example, a region from right front to right rear) of the vehicle 10. The imaging device 14d is positioned at a left-end portion of the vehicle 10, i.e., at a left-side door mirror 10d, for example, to capture an image of a left lateral region (for example, a region from left front to left rear) of the vehicle 10.

The captured image data obtained by the imaging devices 14a to 14d on which arithmetic processing and image processing are performed are used for displaying an image in each direction in the surroundings of the vehicle 10 and monitoring the surroundings of the vehicle 10. In addition, conducting the arithmetic processing and the image processing on the captured image data generates an image with wider viewing angle, generates and displays a virtual image including the vehicle 10 viewed from the above, front, or side (i.e., a bird's eye view image corresponding to a plane image, a side-view image, or a front-view image, for example), and monitors the surroundings of the vehicle 10.

The captured image data obtained by each imaging device 14 are displayed at a display device 16 at a vehicle interior for providing information of surroundings of the vehicle 10 to a user such as a driver of the vehicle 10, for example. The captured image data are provided to a processing device (processing portion) that performs various detections used for controlling the vehicle 10.

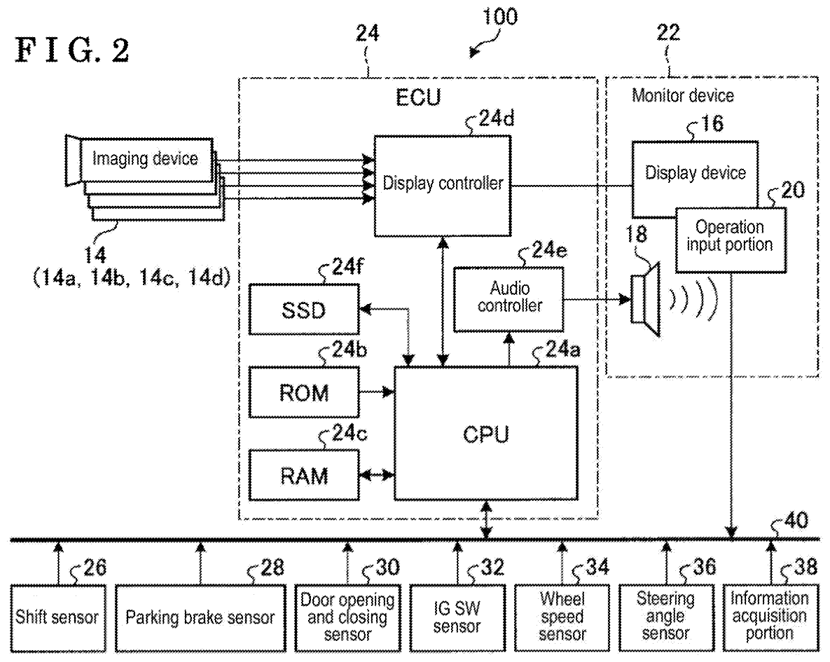

As illustrated in FIG. 2, the display device 16 and an audio output device 18 are provided at the vehicle interior of the vehicle 10. The display device 16 is a liquid crystal display (LCD) or an organic electroluminescent display (OELD), for example. The audio output device 18 is a speaker, for example. The display device 16 is covered with an operation input portion 20 that is transparent such as a touch panel, for example. The user of the vehicle 10 may visually confirm an image displayed at a display screen of the display device 16 via the operation input portion 20. The user may input his/her operation to the operation input portion 20 by touching, pressing down, or moving the operation input portion 20 with his/her finger, for example, at a position corresponding to the image displayed at the display screen of the display device 16. The display device 16, the audio output device 18, and the operation input portion 20, for example, are provided at a monitor device 22 that is arranged at a substantially center of a dashboard of the vehicle 10 in the vehicle width direction, i.e., in a right and left direction. The monitor device 22 may include an operation input portion such as a switch, a dial, a joystick, and a pressing bottom, for example. The monitor device 22 may be also used for a navigation system or an audio system.

A vehicle control system 100 including the surroundings monitoring apparatus includes an electronic control unit (ECU) 24, a shift sensor 26, a parking brake sensor 28, a door opening and closing sensor 30, an ignition switch sensor (IG SW sensor) 32, a wheel speed sensor 34, a steering angle sensor 36, and an information acquisition portion 38, for example, in addition to the imaging devices 14 (14a to 14d) and the monitor device 22. The ECU 24, the monitor device 22, the shift sensor 26, the parking brake sensor 28, the door opening and closing sensor 30, the IG SW sensor 32, the wheel speed sensor 34, the steering angle sensor 36, and the information acquisition portion 38, for example, in the vehicle control system 100 are electrically connected to one another via an in-vehicle network 40 serving as an electrical communication line. The in-vehicle network 40 is configured as a controller area network (CAN), for example. The ECU 24 transmits a control signal through the in-vehicle network 40 to control various systems such as a drive system, a steering system, and a brake system, for example. The ECU 24 also receives, through the in-vehicle network 40, operation signals of the operation input portion 20 and various switches, detection signals of various sensors such as the shift sensor 26, the parking brake sensor 28, the door opening and closing sensor 30, the IGSW sensor 32, the wheel speed sensor 34, and the steering angle sensor 36, for example, and position information acquirable by the information acquisition portion 38. Various systems such as the steering system, the brake system, and the drive system, for example, for driving the vehicle 10 and various sensors are connected to the in-vehicle network 40. In FIG. 2, configurations not essential for the surroundings monitoring apparatus are not illustrated and explanation thereof is omitted.

The ECU 24 transmits data of a peripheral (surroundings) image generated on a basis of the captured image data acquired from the imaging devices 14 and data related to sound to the monitor device 22. The ECU 24 includes a central processing unit (CPU) 24a, a read only memory (ROM) 24b, a random access memory (RAM) 24c, a display controller 24d, an audio controller 24e, and a solid state drive (SSD) (flash memory) 24f, for example.

The CPU 24a reads out program (i.e., surroundings monitoring program, for example) installed and stored at a non-volatile storage unit such as the ROM 24b, for example, and performs an arithmetic processing in accordance with such program. The ROM 24b stores various programs, parameters for executing such programs, and a pre-trained model which is trained beforehand using plural data for restoring a captured image, for example. The RAM 24c is used as a work area when the CPU 24a performs a restoration processing for obtaining a restoration image and also used as a tentative storage area of various data (for example, captured image data obtained sequentially, i.e., by a time series, by the imaging devices 14) used for calculation at the CPU 14a. The display controller 24d synthesizes or combines image data displayed at the display device 16 mainly among the arithmetic processing performed at the ECU 24, for example. The audio controller 24e performs a processing of audio data output from the audio output device 18 mainly among the arithmetic processing performed at the ECU 24. The SSD 24f that is a rewritable non-volatile storage unit is configured to store data even when a power source of the ECU 24 is turned off. The CPU 24a, the ROM 24b, and the RAM 24c, for example, may be integrated within the same package. The ECU 24 may be constructed to use another arithmetic logic processor or logic circuit such as a digital signal processor (DSP), for example, instead of the CPU 24a. In addition, a hard disk drive (HDD) may be provided instead of the SSD 24f, or the SSD 24f and the HDD may be provided separately from the ECU 24, for example.

The shift sensor 26 detects a position of a movable part of a gear change operation portion (for example, a lever, an arm, and a button) of the vehicle 10. The shift sensor 26 is configured to detect whether the movable part of the gear change operation portion is in a parking (P) range (a parking position), for example. When the movable part of the gear change operation portion is in the parking range, it is regarded that the user of the vehicle 10 has operated the vehicle 10 so that the user is able to get out of the vehicle 10.

The parking brake sensor 28 detects a position of an operation portion such as a lever, a switch, and a pedal that is connected to the wheels 12 of the vehicle 10 to maintain a state where a braking force of a disc brake is generated, for example. In a case where the aforementioned position of the lever, the switch, or the pedal indicating that the parking brake is being operated (i.e., in a braking force generated state), it is regarded that the user of the vehicle 10 has operated the vehicle 10 so that the user is able to get out of the vehicle 10.

The door opening and closing sensor 30 detects opening/closing of each of front and rear passenger doors and a driver side door. The door opening and closing sensor 30 is arranged at a hinge portion of each door, for example, to detect that the door is opened to an opening angle at which a passenger is easily or comfortably able to get in and out through the door. When the door is detected as opening to the opening angle at which the passenger is easily or comfortably able to get in and out through the door, it is regarded that the user of the vehicle 10 has operated the vehicle 10 so that the user is able to get out of the vehicle 10.

The IGSW sensor 32 detects an operation state of a power switch for bringing the vehicle 10 to a driving state. The IGSW sensor 32 detects a state of an ignition switch where a key is inserted into a cylinder, for example, based on a rotation position of the key or a state of a circuit that is connected via the rotation of the key. The IGSW sensor 32 also detects a state of an ignition switch that is constituted by a push switch, for example, based on a state of a circuit which is determined by the operation of the push switch. In a case where an inoperative state of the vehicle 10 (for example, stop of an engine or a motor, and power-off) is detected on a basis of the state of the ignition switch, it is regarded that the user of the vehicle 10 has operated the vehicle 10 so that the user is able to get out of the vehicle 10.

The wheel speed sensor 34, which is configured with a Hall element, for example, detects an amount of rotations of each wheel 12 and the number of rotations (a rotation speed) thereof per time unit. The wheel speed sensor 34 is arranged at each wheel 12 to output wheel speed pulse number indicating the number of rotations detected at each wheel 12 as a sensor value. The CPU 24a determines the speed of the vehicle 10 based on the speed of one of the wheels 12 having the smallest sensor value among four wheels of the vehicle 10 and performs various controls when calculating the speed of the vehicle 10 based on the sensor value acquired from each wheel speed sensor 34. In the embodiment, the speed of the vehicle 10 is usable for determining whether to perform the restoration processing for obtaining the restoration image, which is explained later.

The steering angle sensor 36, which is configured with a Hall element, for example, detects a steering amount of a steering wheel, for example. The CPU 24a acquires a steering amount of a steering wheel by the driver and a steering amount of each wheel 12 upon automatic steering, for example, from the steering angle sensor 36 to perform various controls. The steering angle sensor 36 detects a rotation angle of a rotary part of the steering wheel. In the embodiment, the steering amount is usable for determining whether to perform the restoration processing for obtaining the restoration image, which is explained later.

The information acquisition portion 38 receives a GPS signal transmitted from a global positioning system (GPS), for example, to acquire the present position of the vehicle 10 and weather information transmitted from an outside information center, for example. The information acquisition portion 38 utilizes such information for various controls. The position information of the vehicle 10 and the outside information may be acquired by a navigation system in a case where the monitor device 22 includes the navigation system. In the present embodiment, the information acquired by the information acquisition portion 38 is usable for determining whether to perform the restoration processing for obtaining the restoration image, which is explained later.

In the embodiment, the ECU 24 controls a processing for generating the restoration image that indicates a state where a stain is seemingly or apparently removed from the captured image, i.e., a state where no stains exist (i.e., a generation processing, the restoration processing) and a processing for determining whether to display the aforementioned restoration image (i.e., a display processing).

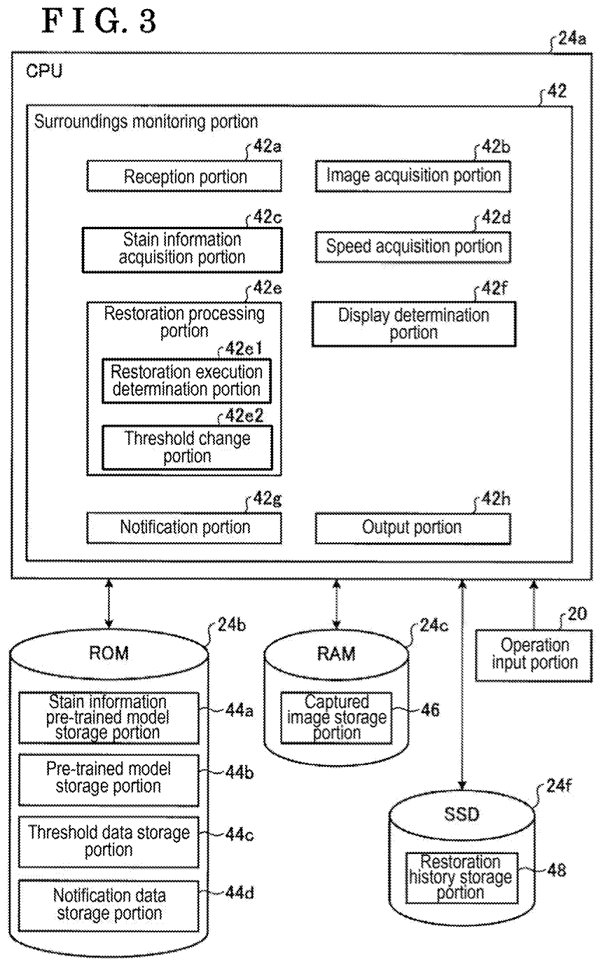

As illustrated in FIG. 3, the CPU 24a in the ECU 24 includes a surroundings monitoring portion 42. The surroundings monitoring portion 42 includes various modules for achieving a restoration processing function to generate the restoration image where the stain in the captured image is seemingly removed or eliminated. For example, the surroundings monitoring portion 42 includes a reception portion 42a, an image acquisition portion 42b (an acquisition portion), a stain information acquisition portion 42c, a speed acquisition portion 42d, a restoration processing portion 42e, a display determination portion 42f, a notification portion 42g, and an output portion 42h, for example. The aforementioned modules may be configured as exclusive hardware. The restoration processing portion 42e performs a processing using deep-learning, for example, that requires a huge amount of parallel computations. Thus, a graphics processing unit (GPU) or a field-programmable gate array (FPGA) may be utilized, for example. The surroundings monitoring portion 42 includes a module for detecting an obstacle and a white line, for example, as a surroundings monitoring processing. Illustrations of modules other than those for the restoration processing are omitted in FIG. 3, and explanations thereof are also omitted.

The ROM 24b stores model data used for generating the restoration image, threshold data that are referred to for executing various determinations and message data used for various notifications or alerting, for example, in addition to various programs performed at the CPU 24a. The ROM 24b includes a stain information pre-trained model storage portion 44a, a pre-trained model storage portion 44b, a threshold data storage portion 44c, and a notification data storage portion 44d, for example.

The stain information pre-trained model storage portion 44a stores a stain information pre-trained model provided to calculate probability of existence of a stain (stains) such as raindrops, for example, per pixel in the captured image serving as a target of restoration, the stain information pre-trained model being used at the stain information acquisition portion 42c. In constructing the stain information pre-trained model, certainty of a stain in each pixel of each training image is indicated by an evaluation value between zero (0) and one (1) under the condition that the value indicating no stain is defined to be zero and the value indicating existence of a stain is defined to be one. The stain information pre-trained model is constructed on a basis of the training images including evaluation values, the training images on which training or learning is made with a machine learning method such as deep-learning, for example. The captured image (data) captured by the imaging devices 14 is input to the stain information pre-trained model to determine the weight of numbers of pixels (the number of pixels) with the evaluation value being closer to one to thereby output the position and the size of the stain (size of an area of the stain), for example.

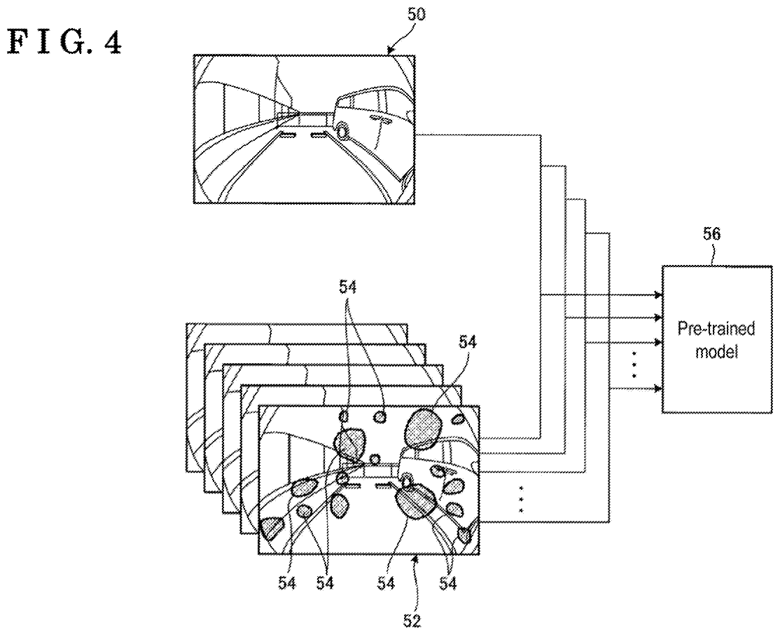

The pre-trained model stored at the pre-trained model storage portion 44b is used at the restoration processing portion 42e. The pre-trained model is utilized in a case where the restoration image in which an area hidden by the stain is restored to an area with no stains is generated, the restoration image serving as the latest captured image among plural captured images captured on a time-series basis by the imaging devices 14 mounted at the vehicle 10 while the vehicle 10 is moving. FIG. 4 illustrates a concept of construction of the pre-trained model. As illustrated in FIG. 4, a pre-trained model 56 serves as a model that has learnt a relationship between a training image 50 where training stains 54 (for example, raindrops) are absent and plural training stain images 52 obtained by plural training images including the training stains 54 by a known machine learning method such as deep-learning, for example. Details of restoration processing using the pre-trained model are explained later.

The threshold data storage portion 44c stores a threshold value that is referred to when the restoration processing portion 42e determines whether to perform the restoration processing.

The notification data storage portion 44d stores messages to be informed so that the user of the vehicle 10 may easily recognize whether the restoration image is displayed, and the user may be encouraged to clean a lens, for example, in a case where the stain is presumably adhered to the imaging device 14, and a message word including plural messages combined to each other.

The RAM 24c is used as a work area in a case where the CPU 24a performs the restoration processing to obtain the restoration image. The RAM 24c includes, for example, a captured image storage portion 46 tentatively storing captured image data (i.e., captured image data sequentially captured, by a time series, by the imaging devices 14) used for calculations at the CPU 24a. The captured image storage portion 46 sequentially stores the captured image data until a predetermined storage area becomes full and, when the predetermined storage area becomes full, deletes the captured images beginning with the chronologically oldest image so as to secure a storage area for new captured image data. The captured image storage portion 46 constantly holds the captured image data for a predetermined time period accordingly.

The SSD 24f includes a restoration history storage portion 48 storing a living history of the restoration image, for example, as data that is stored when a power supply of the ECU 24 is turned off. The restoration history storage portion 48 stores data indicating which imaging device 14 among the plural imaging devices 14 captures the captured image data that has been restored and data indicating time at which the restoration is made and degree of restoration as the restoration history. The SSD 24f stores restoration contents in a case where the restoration image is displayed before the power supply of the ECU 24 is turned off (i.e., before the driver gets out of the vehicle), for example. When the power supply of the ECU 24 is turned on (for example, the driver gets in the vehicle for driving), whether the image restoration is conducted before the power supply of the ECU 24 is turned off is thus determinable. When the power supply of the ECU 24 is turned off while the restoration image is being displayed and is thereafter turned on again, the display of the restoration image is not allowed (i.e., prohibited) in a case where the imaging device 14 is not cleaned though the cleaning of the imaging device 14 is available before the user gets in the vehicle 10. In another embodiment, the restoration history may be held for a predetermined time period for use in acquiring tendency of restoration, for example. Nevertheless, the restoration history is discarded basically under the condition where the stain is eliminated to inhibit excess of storage capacity of the SSD 24f.

The reception portion 42a receives a request signal in a case where generation of restoration image is requested. The restoration image may be generated automatically when the stain is detected in the captured image while the vehicle 10 is being driven, for example (automatic restoration mode). In addition, the restoration image may be manually generated at timing where the user of the vehicle 10 desires the restoration image through the operation input portion 20 because an image displayed at the display device 16 is difficult to be seen due to the stain, for example (manual restoration mode). The reception portion 42a receives the request signal from the surroundings monitoring portion 42 in a case where the generation of restoration image is automatically requested. The reception portion 42a receives an operation signal from the operation input portion 20, for example, via the in-vehicle network 40 in a case where the generation of restoration image is manually requested. The restoration image generated by the surroundings monitoring portion 42 according to the embodiment is displayed as an emergency procedure upon occurrence of the stain during a limited time period until the non-display condition is satisfied. The request signal may be thus not output by the surroundings monitoring portion 42 depending on the display state of the restoration image even when the automatic restoration mode is selected. In addition, the manual restoration mode may not be effective, i.e., the operation of the operation input portion 20 may be impossible. The restoration image is an image where stains are removed, which may cause the user of the vehicle 10 not to realize that the image displayed at the display device 16 is the restoration image. It is thus desirable that the restoration image may be displayed in the automatic restoration mode so that the user may easily recognize that the image displayed at the display device 16 is the restoration image.

The image acquisition portion 42b acquires the captured image data captured by each of the imaging devices 14 at a predetermined frame rate and stores such data at the captured image storage portion 46 of the RAM 24c. The image acquisition portion 42b is configured to sequentially acquire the captured image data captured by the imaging devices 14 when the power supply of the vehicle 10 (specifically, the ECU 24) is turned on. The image acquisition portion 42b acquires the captured image data identified on a basis of the respective imaging devices 14 (14a to 14d) and stores the aforementioned data at the captured image storage portion 46. The captured image storage portion 46 thus stores the captured image data as frame data that continue in time-series per imaging device 14. The captured image storage portion 46 is able to store the captured image data for a predetermined time period, for example, for 3 to 5 seconds, and to sequentially overwrite the captured image data. The captured image storage portion 46 is thus able to provide the restoration processing portion 42e with the latest captured image and plural past images obtained chronologically backwards from the latest captured image for a predetermined time period. The captured image storage portion 46 may store the captured image data obtained while the vehicle 10 is being driven by a predetermined distance as an example of the case where the captured image storage portion 46 stores the captured image data for a predetermined time period.

The stain information acquisition portion 42c acquires information of whether the stain exists in the captured image and, when the stain exists in the captured image, acquires the position and the size of such stain by inputting the captured image including the stain to the stain information pre-trained model that is read out from the stain information pre-trained model storage portion 44a of the ROM 24b. The stain information acquisition portion 42c sequentially provides acquired stain information to the restoration processing portion 42e. In a case where splash of mud or dust serving as the stain is adhered to the imaging device 14, for example, such stain is less possible to move on the lens of the imaging device 14 while the vehicle 10 is being driven. On the other hand, raindrops, for example, serving as the stain is easily movable or deformable (i.e., the size of raindrop may change) on the lens of the imaging device 14 by a wind pressure generated while the vehicle 10 is being driven. The stain information acquisition portion 42c thus sequentially acquires the stain information per captured image at least while the restoration processing portion 42e is performing the restoration processing.

The speed acquisition portion 42d acquires the present speed and acceleration of the vehicle 10 based on the detection value of the wheel speed sensor 34. The speed acquisition portion 42d provides the vehicle speed to the restoration processing portion 42e. The vehicle speed is utilized for determining whether to perform the restoration processing in a case where the non-display condition that prohibits the display of the restoration image is not satisfied. Details of usage of vehicle speed are explained later.

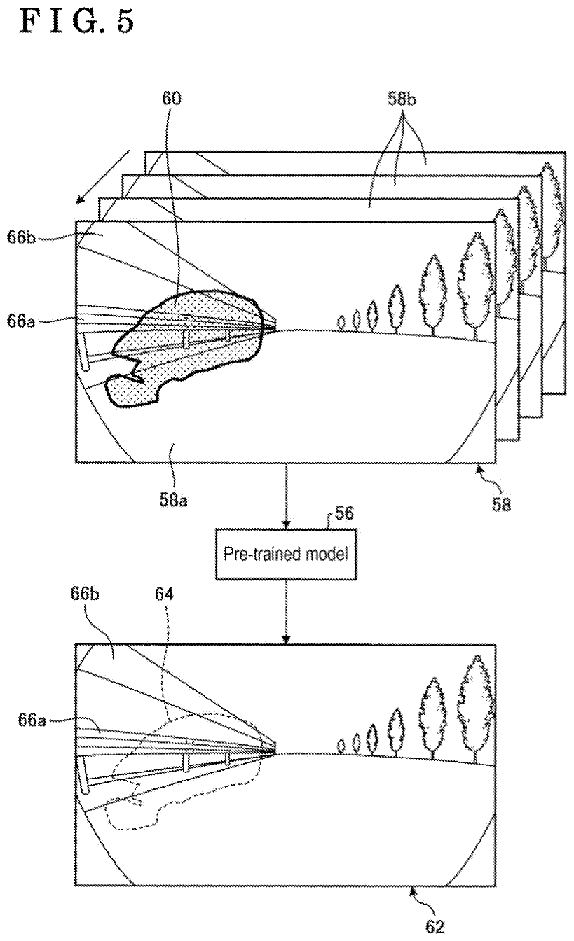

The restoration processing portion 42e restores the captured image serving as a restoration target. The restoration processing portion 42e performs the restoration processing as illustrated in FIG. 5 that illustrates a case where a front image captured by the imaging device 14a among the plural imaging devices 14 is restored, the front image being the captured image serving as the restoration target.

As illustrated in FIG. 5, the restoration processing portion 42e inputs plural captured images 58 to the pre-trained model 56, the plural captured images 58 being sequentially captured by the imaging device 14a and stored in chronological order at the captured image storage portion 46 of the RAM 24c. At this time, information about the stain such as the position and the size of a stain 60 (for example, splash of mud) in the captured image 58 is recognizable by stain information provided from the stain information acquisition portion 42c. In the pre-trained model 56, the restoration processing is sequentially performed on an area having high possibility of existence of the stain 60. The restoration processing is performed on a latest captured image 58a among the plural chronologically captured images 58. At this time, an area hidden by the stain 60 in the latest captured image 58a may appear, without being hidden by the stain 60, in past images 58b captured by the imaging devices 14 and obtained in chronologically past relative to the latest captured image 58a. The pre-trained model 56 is able to generate a restoration image 62 where the area hidden by the stain 60 is highly probably restored by receiving information of the plural past images 58b so as to improve quality of restoration image. In FIG. 5, a part of a guard rail 66a and a part of a fence 66b which are hidden by the stain 60 in the captured image 58 are restored at a restoration region 64 in the restoration image 62. The guard rail 66a and the fence 66b are confirmable in the restoration image 62 accordingly.

The restoration processing portion 42e includes a restoration execution determination portion 42e1. The restoration processing portion 42e performs the restoration processing using the plural captured images 58 that include the latest captured image 58a and the past images 58b. The past images 58b usable for the restoration processing are limited to those including things or objects captured in the latest captured image 58a. In a case where the vehicle 10 is being driven, the past images 58b captured during a period a few seconds before the present time, for example, are usable for the restoration processing. In circumstances where the past images 58b usable for the restoration processing are limited, the restoration processing using the plural captured images 58 including the latest captured image 58a and the past images 58b may not achieve sufficient restoration if the large stain is included in the latest captured image 58a. For example, in a case where the size of the stain 60 exceeds a size defined by a predetermined threshold value, an object may be kept hidden by the stain 60 in the past images 58b. In this case, an area hidden by the stain 60 is inhibited from being sufficiently restored in the latest captured image 58a. The restoration processing by the restoration processing portion 42e is not desirable accordingly. The restoration execution determination portion 42e1 is thus inhibited from performing the restoration processing unless a restoration available condition is satisfied. The restoration execution determination portion 42e1 compares the size of the stain 60 in the latest captured image 58a included in the stain information acquired by the stain information acquisition portion 42c with the predetermined threshold value. In a case where the size of the stain 60 is equal to or greater than the threshold value, the restoration execution determination portion 42e1 determines that the area where the stain 60 exists is unable to be restored and causes the restoration processing no to be performed.

The aforementioned threshold value may be a constant value or a variable value. Specifically, depending on the speed of the vehicle 10, the restoration of the captured image may be impossible. For example, when the moving speed of the vehicle 10 is high in a state where the size of the stain 60 is large, the stain 60 hiding an area in the latest captured image 58a may possibly hide a distant area in the past image 58b from the aforementioned area hidden in the latest captured image 58a. That is, in a case where the moving distance of the vehicle 10 is large, possibility that the area hidden by the stain 60 in the latest captured image 58a is captured in the past image 58b obtained chronologically backwards from the latest captured image 58a increases. On the contrary, when the moving speed of the vehicle 10 is low in a state where the size of the stain 60 is small, a moving amount of the stain 60 between the latest captured image 58a and the past image 58b is small. The area hidden by the stain 60 in the past image 58b that is obtained chronologically backwards from the latest captured image 58a may be still possibly hidden by the stain 60 in the latest captured image 58a. A threshold change portion 42e2 thus changes a threshold value for determining availability of executing the restoration processing depending on the speed of the vehicle 10 and the size of the stain 60. The threshold change portion 42e2 reads out a threshold map correlating the speed of the vehicle 10 and the size of the stain 60 from the threshold data storage portion 44c of the ROM 24b. The threshold change portion 42e2 acquires the present speed of the vehicle 10 from the speed acquisition portion 42d and the size of the stain 60 from the stain information acquired by the stain information acquisition portion 42c at the time the restoration processing portion 42e performs the restoration processing and refers to the threshold map. The threshold change portion 42e2 determines or changes the threshold value that is most appropriate for determining the availability of performing the restoration processing in the present circumstances and provides the determined threshold value to the restoration processing portion 42e. The restoration processing portion 42e determines whether to perform the restoration processing based on the provided threshold value.

The restoration image 62 is a synthetic image generated by eliminating the stain 60 in the captured image using image processing. An image that possibly corresponds to an area hidden by the stain 60 in the captured image is superimposed on the aforementioned area. In a case where an object is present at such area hidden by the stain 60 at some instant, the object may fail to be restored and recognized by the user of the vehicle 10. The restoration image 62 used (i.e., displayed) for a long time period may decrease reliability as a peripheral (surroundings) image accordingly. The display determination portion 42f of the surroundings monitoring portion 42 thus determines whether to keep or stop the display of the restoration image 62. In the present embodiment, the user is inhibited from being bothered by getting out of the vehicle 10 only to clean the imaging device 14 (remove the stain 60) when the stain 60 is attached to the imaging device 14. In addition, the display of the restoration image 62 at the display device 16 causes the display device 16 to be used for an emergency procedure. Meanwhile, the user is encouraged to clean the imaging device 14 (remove the stain 60) when getting out of the vehicle 10 with no intention of cleaning the imaging device 14, so that the user may have less feeling of getting out of the vehicle only for cleaning the imaging device 14. Nevertheless, when the user does not clean the imaging device 14 even though the user gets out of the vehicle 10 in a state where the stain 60 is adhered to the imaging device 14 (i.e., when the restoration image 62 is generated and displayed), the display of the restoration image 62 is stopped (prohibited) and the captured image 58 where the stain 60 remains is displayed. The display of the captured image 58 including the stain 60 may cause the user to easily recognize presence of the stain 60 and emphasize necessity of removing the stain 60 (cleaning the imaging device 14).

The display determination portion 42f determines whether a vehicle operation that enables the user of the vehicle 10 to get out of the vehicle 10 is made in a case where the restoration image 62 is displayed by the restoration processing portion 42e. The display determination portion 42f acquires a result of whether the present position of the gear change operation portion is in the parking (P) range in accordance with a detection result of the shift sensor 26, for example, in a state where the restoration image 62 is displayed (i.e., generation of the restoration image 62 is allowed). When the present position of the gear change operation portion is in the P range, the display determination portion 42f determines that the user of the vehicle 10 such as the driver, for example, is in a state of being able to get out of the vehicle 10. Then, in a case where the stain 60 is kept adhered to the imaging device 14 even though the position of the gear change operation portion is changed from the P range to the other range such as a drive (D) range (i.e., a range where the parking state of the vehicle 10 is released), for example, it is determined that the imaging device 14 has not been cleaned even though the driver has had a chance getting out of the vehicle 10. That is, the non-display condition causing the restoration image 62 not to be displayed is regarded to be satisfied, so that the display of the restoration image 62 is terminated (prohibited). The captured image 58 including the stain 60 is displayed at the display device 16 so that the restoration image 62 where an object different from an actual one may be possibly positioned at the restoration region 64 is avoided from being continuously displayed.

The determination of whether the imaging device 14 is cleaned (i.e., the stain 60 is removed) is performed using a known stain detection method. For example, whether the stain 60 is removed is determinable by comparing plural (for example, two) captured images acquired before and after a time period where the stain 60 is possible to be removed (i.e., the user gets out of the vehicle 10). Specifically, the restoration image 62 obtained at the time the position of the gear change operation portion is detected to be shifted to the P range and the restoration image 62 obtained at the time the position of the gear change operation portion is thereafter shifted to the D range are compared for the aforementioned determination. In a case where the imaging device 14 is not cleaned (the stain 60 is not removed), a change between the two restoration images 62 is small. On the other hand, in a case where the imaging device 14 is cleaned (the stain 60 is removed), the change between the two restoration images 62 is large because of elimination of the stain 60. The determination of whether the imaging device 14 is cleaned is thus achieved. Another method of detecting the stain 60 is, for example, a known detection using spatial frequency. The captured image captured by the imaging device 14 (for example, the imaging device 14a) to which Fast Fourier Transformation (FFT) is performed is changed to be indicated with frequency range. In this case, adhesion of the stain 60 to the imaging surface such as a lens, for example, causes light at such imaging surface to be blurred, so that an edge of an object captured in the image becomes blurred. That is a high frequency portion is damped. Occurrence of such incident leads to the determination that the stain 60 is adhered to the imaging surface of the imaging device 14.

The display determination portion 42f may also determine whether the vehicle operation that enables the user of the vehicle 10 to get out of the vehicle 10 is made using a detection result of the parking brake sensor 28. Specifically, when the vehicle operation that activates the parking brake is performed, the user is assumed to get out of the vehicle 10. The display determination portion 42f may also utilize a detection result of the door opening and closing sensor 30. In this case, possibility of the user getting out of the vehicle 10 is more accurately detectable. The display determination portion 42f may further utilize a detection result of the IGSW sensor 32. In this case, the fact that the vehicle 10 stops driving can be estimated, which leads to an estimation that the user of the vehicle 10 highly possibly gets out of the vehicle 10.

In the embodiment, the sensor (i.e., the parking brake sensor 28) is employed to determine whether the vehicle operation that enables the user of the vehicle 10 to get out of the vehicle 10 has been made. Instead, detection results of plural sensors may be combined to be utilized for the determination, which may improve determination (estimation) accuracy. Whether the user has an opportunity to clean the imaging device 14 (remove the stain 60) is determinable even in a case where the vehicle 10 is parked for a long time period (for example, a few days). In this case, whether the restoration image 62 is generated and displayed because of existence of the stain 60 before the vehicle 10 is parked for a long time period is confirmable by referring to the restoration history storage portion 48.

When it is determined that the imaging device 14 is cleaned (the stain 60 is removed), the display determination portion 42f terminates the display of the restoration image 62 by the restoration processing portion 42e and displays the captured image 58 on which the restoration processing is not performed at the display device 16. That is, the captured image 58 without the stain 60 is normally displayed.

The vehicle 10 may be kept driven for a long time in a state where the restoration image 62 is generated and displayed at the display device 16. For example, in a case where the vehicle 10 is driven on an expressway, the user of the vehicle 10 may not get out of the vehicle 10 depending on an interval between rest areas (service areas). The restoration image 62 is thus continuously displayed for a long time. In such case, the display determination portion 42f may recognize that the non-display condition is satisfied when the restoration image 62 is displayed for a predetermined time period from the display start of the restoration image 62. Specifically, the display determination portion 42f may determine that the non-display condition is satisfied when 30 minutes is elapsed, for example, from the display start of the restoration image 62 and terminates (prohibits) the display of the restoration image 62, so that an image including the stain 60 (i.e., a non-restoration image) is displayed.

The notification portion 42g informs existence of the stain 60 to the user when the restoration processing portion 42e determines that the captured image 58 includes the stain 60. The notification portion 42g performs at least one of a display notification informing or notifying that the restoration image 62 is displayed at the display device 16 and a non-display notification informing or notifying that the non-display condition of the restoration image 62 is satisfied. That is, the notification portion 42g performs at least one of the display notification while the restoration image 62 is being displayed at the display device 16 and the non-display notification in a case where the non-display condition of the restoration image 62 is satisfied. The notification portion 42g informs the user so that the user is encouraged to clean the imaging device 14 when the vehicle operation that enables the user of the vehicle 10 to get out of the vehicle 10 is made in a state where the restoration image 62 is displayed. The notification portion 42g may read out a message stored at the notification data storage portion 44d of the ROM 24b to display the message at the display device 16 or read out an audio message that is then output via the audio output device 18. The notification portion 42g may combine the aforementioned messages. The messages stored at the notification data storage portion 44d may be fixed messages or messages each of which is constituted by a combination of plural message words.

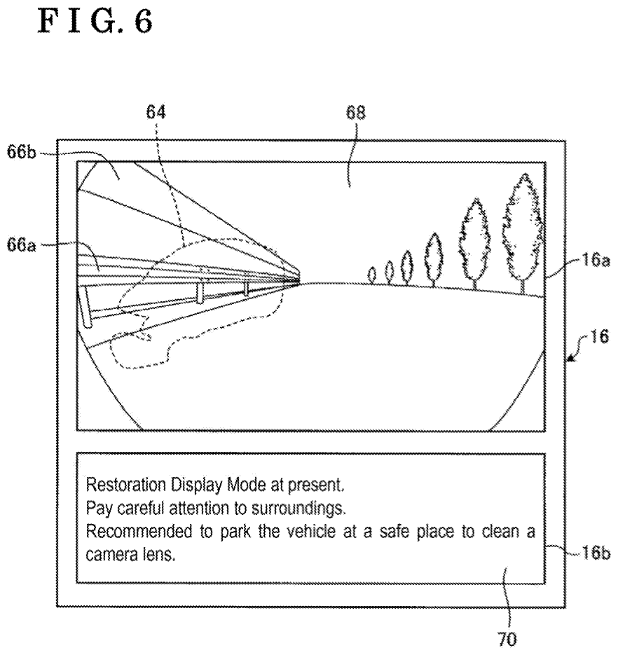

FIG. 6 illustrates an example of the display notification informing the display of a restoration image 68 in a case where the restoration image 68 is displayed. When the restoration image 68 is displayed at the display device 16, the display device 16 is divided into an image display area 16a and a message display area 16b, for example, as illustrated in FIG. 6. In FIG. 6, the restoration image 68 where the guard rail 66a and the fence 66b are restored at the restoration region 64 is displayed at the image display area 16a. In FIG. 6, the restoration region 64 is illustrated for purposes of explanation but in the actual restoration image 68, the restoration processing is performed so that the restoration region 64 is difficult to be recognized. A message 70 (a message generated upon restoration of the image) is displayed at the message display area 16b as the display notification. The message 70 includes contents such as “Restoration Display Mode at present. Pay careful attention to surroundings. Recommended to park the vehicle at a safe place to clean a camera lens.”, for example. In the display notification informing the display of the restoration image 68, cleaning the imaging device 14 is simply recommended while the display of the restoration image 68 is permitted or approved. The aforementioned contents of the message 70 may be displayed for a predetermined time period such as 15 seconds, for example, after the display of the restoration image 68 is started, and thereafter only a part of the message such as “Restoration Display Mode at present” may be displayed at a part of the image display area 16a, for example. The message display area 16b may be thus utilized as or added to the image display area 16a, so that the restoration image 68 is able to be largely displayed. In addition, excess display of the message 70 that may cause the user to feel annoyed is restrained. The message 70 and a part of the message 70 as mentioned above, for example, may be displayed in color easily recognized by the user and not too emphasized (for example, in yellow or orange). The message 70 and a part of the message 70 may be periodically displayed to restrain excess display thereof. The aforementioned contents of the message 70 are examples and may be appropriately changed. In addition, instead of the message 70, an audio message having the similar contents to the message 70 may be output from the audio output device 18. The display of the message 70 and the output of the audio message may be both performed.

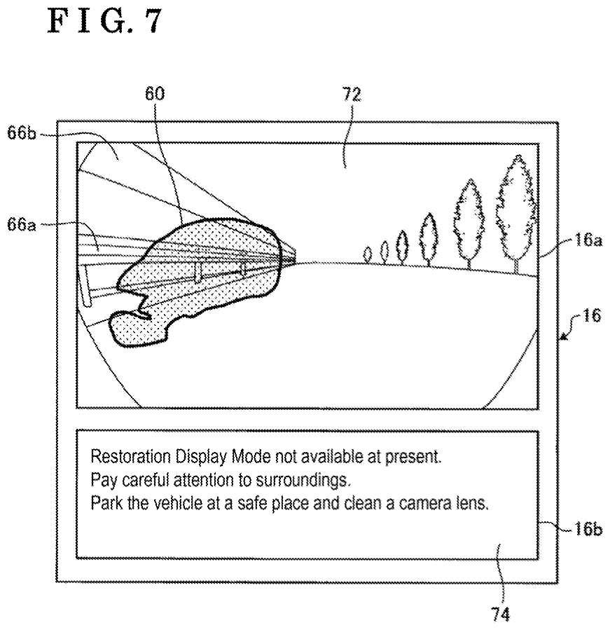

FIG. 7 illustrates an example of the non-display notification informing that the restoration image is not displayed in a case where a non-restoration image 72 is displayed. In the same way as the display of the restoration image 68, the display device 16 is divided into the image display area 16a and the message display area 16b, for example, as illustrated in FIG. 7 in a case where the non-restoration image 72 is displayed at the display device 16. In FIG. 7, the non-restoration image 72 where a part of the guard rail 66a and the fence 66b, for example, are hidden by the stain 60 at the image display area 16a is displayed. A message 74 (a message generated upon non-restoration of the image) is displayed at the message display area 16b at the non-restoration image 72. The message 74 includes contents such as “Restoration Display Mode not available at present. Pay careful attention to surroundings. Park the vehicle at a safe place and clean a camera lens.” for example. In the non-display notification informing that the restoration image is not displayed, necessity of cleaning the imaging device 14 is informed while the display of the non-restoration image 72 is clearly expressed. The aforementioned contents of the message 74 may be displayed for a predetermined time period such as 15 seconds, for example, after the image is switched to the non-restoration image 72 and thereafter only a part of the message “Restoration Display Mode not available” and “Clean a camera lens” may be displayed at a part of the image display area 16a, for example. The message display area 16b may be thus utilized as or added to the image display area 16a, so that the non-restoration image 72 is able to be largely displayed. The user may earlier recognize or notice the stain 60 at the imaging device 14. On the other hand, the message display area 16b may be expanded so that the display of the message 74 causes the user to early recognize unavailable display of the restoration image (restoration mode) or necessity of prompt cleaning of the imaging device 14. The message 74 and a part of the message 74 as mentioned above, for example, may be displayed in color easily recognized by the user (for example, in red) for reminding the user of danger. The aforementioned contents of the message 74 are examples and may be appropriately changed. In addition, instead of the message 74, an audio message having the similar contents to the message 74 may be output from the audio output device 18. The display of the message 74 and the output of the audio message may be both performed. The message informing the user of necessity to clean the imaging device 14 may be generated or output not only during the display of the non-restoration image 72 but also when the non-display condition is satisfied, i.e., at timing when the user gets out of the vehicle 10. The user may thus strongly recognize necessity of cleaning the imaging device 14 when getting out of the vehicle 10. In this case, a message identifying the imaging device 14 to which the stain 60 is adhered or a message indicating the position of the stain 60 on the lens of the imaging device 14, for example, are additionally provided. The user may be further securely encouraged to clean the imaging device 14 accordingly.

The output portion 42h outputs the restoration image 68 generated by the restoration processing portion 42e, the non-restoration image 72 obtained when the display of the restoration image 68 is prohibited, the message 70 related to the restoration image 68, and the message 74 related to the non-restoration image 72 to the display controller 24d so that the aforementioned images and messages are displayed at the display device 16. The audio message is output to the audio controller 24e so that the message is output from the audio output device 18.

The block diagram in FIG. 3 illustrates modules classified depending on functions. The functions may be appropriately integrated or divided.

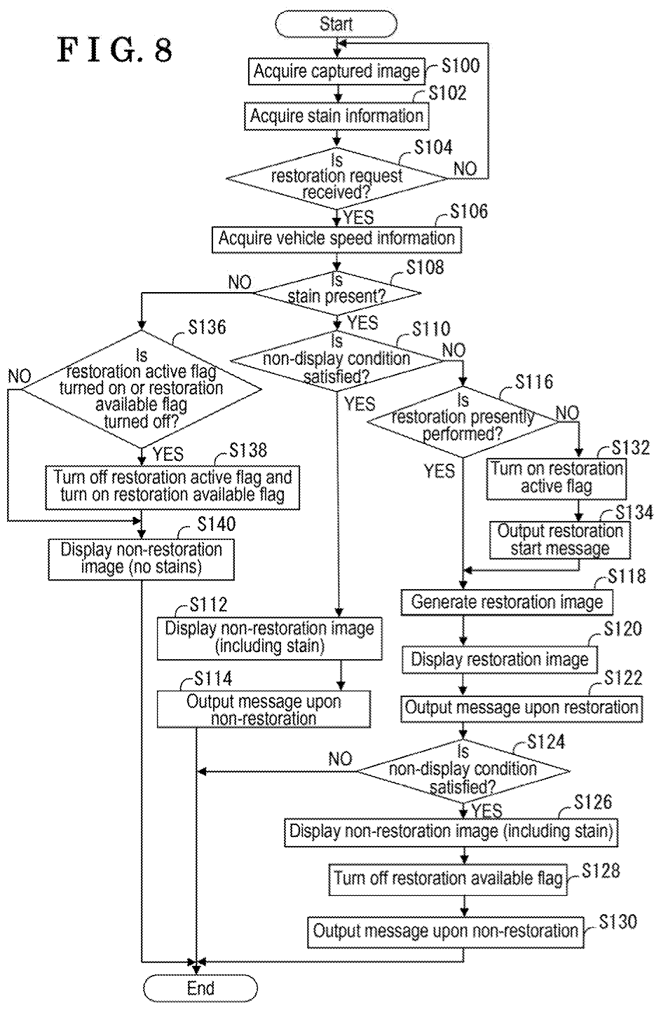

The restoration processing for the captured image according to the aforementioned surroundings monitoring apparatus (the surroundings monitoring portion 42) is explained with reference to a flowchart illustrated in FIG. 8. The processing illustrated in FIG. 8 is repeatedly performed per predetermined period with the power supply of the vehicle 10 being turned on.

When the power supply of the vehicle 10 (the ECU 24) is turned on, the image acquisition portion 42b starts acquiring the captured images by operating the imaging devices 14 (S100) and sequentially stores the captured images at the captured image storage portion 46 of the RAM 24c. The stain information acquisition portion 42c starts acquiring the stain information relative to the captured images captured by the imaging devices 14 (S102). The stain information acquisition portion 42c sequentially inputs the captured images to the stain information pre-trained model that is read out from the stain information pre-trained model storage portion 44a and acquires information of whether the stain exists and, when the stain exists, the stain information indicating the size and the position of such stain.

The reception portion 42a then confirms whether the reception portion 42a has received a restoration request signal (S104). In a case where the restoration request signal has not received, the processing returns to S100 (No at S104). The reception portion 42a receives the restoration request signal in a case where the user requests the display of the restoration image via the operation input portion 20 (i.e., the manual restoration mode is selected), or the stain information acquisition portion 42c detects a stain (stains) based on the stain information acquired by the stain information acquisition portion 42c (automatic restoration mode is selected) (Yes in S104). When the reception portion 42a receives the restoration request signal, the speed acquisition portion 42d starts acquiring the present speed of the vehicle 10 (vehicle speed information) (S106). The display determination portion 42f determines whether the stain 60 is present in the captured image 58 that is intended to be presently displayed (i.e., whether the imaging device 14 is dirty) (S108). Such determination is obtained by employing Fast Fourier Transformation (FFT) or comparing display contents of the plural captured images 58 that are temporally adjacent to each other. The acquisition result of the stain information acquisition portion 42c may be also utilized for the determination. In a case where the display determination portion 42f determines that the imaging device 14 is stained (Yes at S108), i.e., in a case where the stain 60 is determined to exist in the captured image 58 as illustrated in FIG. 5, it is determined whether the non-display condition is established (S110). The display determination portion 42f determines that the non-display condition is satisfied in a case where the stain 60 is still present after the vehicle operation that enables the user of the vehicle 10 to get out of the vehicle 10 is made or in a case where the restoration image 68 is kept displayed for a predetermined time period after the display of the restoration image 68 is started (Yes in S110). In this case, the display determination portion 42f stops (prohibits) the display of the restoration image 68. The display determination portion 42f displays the non-restoration image 72 (including the stain 60) at the image display area 16a of the display device 16 (S112) and displays the message 74 (the message upon non-restoration of the image) at the message display area 16b (S114). The present operation is terminated.

When the display determination portion 42f determines that the non-display condition is not satisfied (No in S110), i.e., the restoration image 68 is allowed to be displayed, the display determination portion 42f determines whether the restoration processing is presently performed (S116). In a case where the display determination portion 42f determines that the restoration processing is presently performed (Yes in S116), the restoration processing portion 42e performs the restoration processing on the present captured image 58 and generates the restoration image 68 (S118). The output portion 42h outputs the aforementioned restoration image 68 to the display controller 24d so that the restoration image 68 is displayed at the image display area 16a of the display device 16 (S120). The output portion 42h outputs the message 70 (the message upon restoration of the image) so that the message 70 is displayed at the message display area 16b (S122). When the display determination portion 42f determines that the non-display condition is not satisfied at this point (No in S124), the present operation is terminated. That is, in a case where the vehicle operation that enables the user of the vehicle 10 to get out of the vehicle 10 is not made or a predetermined time period has not elapsed from the start of display of the restoration image 68, the display of the restoration image 68 is continued.

When the display determination portion 42f determines that the non-display condition is satisfied (Yes in S124), the output portion 42h terminates the display of the restoration image 68 and displays the non-restoration image 72 (including the stain 60) at the image display area 16a of the display device 16 (S126). The display determination portion 42f turns off a restoration available flag that allows the restoration of the restoration image 68 (S128). The output portion 42h outputs the message 74 (the message upon non-restoration of the image) that is displayed at the message display area 16b. The present operation is terminated.

In a case where the restoration processing is not presently performed (No in S116), i.e., in a state where the stain 60 is present at the captured image so that the generation of the restoration image 68 is started from that point, the display determination portion 42f turns on a restoration active flag (S132) to cause the output portion 42h to output a restoration start message indicating that the display of the restoration image 68 is started at the display device 16 (S134). The operation is shifted to S118.

When the display determination portion 42f determines that the imaging device 14 is not stained (No in S108), i.e., when the stain 60 is not found or confirmed by using the FFT or comparing display contents of the plural captured images 58 that are temporally adjacent to each other, the display determination portion 42f turns off the restoration active flag and turns on the restoration available flag (S138) in a state where the restoration active flag is turned on or the restoration available flag is turned off (Yes in S136). The display determination portion 42f causes the output portion 42h to normally display the non-restoration image, i.e., the captured image 58 where the stain 60 is not present, at the display device 16 (S140). The present operation is terminated. In this case, outputting any message is not necessary. The display device 16 includes the image display area 16a that is enlarged with the message display area 16b.

The surroundings monitoring apparatus (the surroundings monitoring portion 42) according to the present embodiment achieves the display of the restoration image in a case where the stain is included in the captured image, so that such stain is seemingly not present in the restoration image. In this case, when the non-display condition is satisfied, since then, the display of the restoration image is stopped and prohibited. Specifically, the display of the restoration image is performed as an emergency procedure, being limited to “one-trip” of a vehicle serving as one driving from its start to stop. Alternatively, the restoration image is displayable after an elapse of a predetermined time period from the start of the display of the restoration image during the one-trip of the vehicle. Although the restoration image is tentatively utilized, the restoration image is avoidable from being continuously utilized for a long time. The surroundings monitoring apparatus is operated in a state where convenience achieved by continuously monitoring the surroundings of the vehicle without removing the stain each time the stain is adhered to the imaging device, and securement of reliability by avoiding the restoration image from being displayed for a long time are well-balanced. According to the embodiment, whether to display the restoration image is determined by referring to the restoration history when the vehicle 10 is newly driven after the one-trip is completed. In this case, when the user is changed after the one-trip of the vehicle, i.e., a new user who does not know the display of the restoration image in the past and necessity of cleaning the imaging device 14 gets in the vehicle 10, the restoration image is not displayed when the imaging device 14 is not cleaned. The restoration image is securely inhibited from being kept displayed without the user knowing.

In the aforementioned embodiment, the display of the restoration image is inhibited in a case where the non-display condition is satisfied. In this case, the restoration image may be continuously generated. Alternatively, the generation of the restoration image may be stopped (prohibited) so as not to be displayed at the display device, which may lead to the similar effect. In a case where the display of the restoration image is stopped (prohibited), the other surroundings monitoring processing such as an obstacle detection processing and an automatic driving processing, for example, may be continued or may be stopped (prohibited) when the display of the restoration image is stopped.

In the embodiment, availability of performing the restoration processing is determined on a basis of the threshold value that is specified (changed) by the size of the stain 60 and the speed of the vehicle 10. Alternatively, the threshold value may be changed in view of the steering angle and the acceleration of the vehicle 10, for example. In a case where the vehicle 10 greatly changes its direction that is detected on a basis of the detection value of the steering angle sensor 36, for example, possibility that an area hidden by the stain 60 in the latest captured image 58a is not hidden in the past image 58b obtained chronologically backwards from the latest captured image 58a increases even in a state where the size of the stain 60 is large or the vehicle speed is low. The aforementioned possibility also increases when the vehicle 10 is accelerated. The threshold value is optimized with steering information and acceleration information to appropriately perform the restoration processing. In addition, the threshold value may be changed in view of position information of the vehicle 10 or weather information at a place where the vehicle 10 is positioned, acquirable from the information acquisition portion 38. In a case where the number of raindrops on the captured image 58 is determined to be extremely large because of heavy rain, for example, the threshold value may be changed so that the restoration processing is not performed even when the size of each raindrop is small.

In the embodiment, the restoration processing is performed on the front image so that the restoration image where the stain is seemingly not present is obtained. Alternatively, the restoration processing may be performed in the same manner on the other captured images such as a rear image, a right-side image and a left-side image, for example. The restoration processing of the embodiment may be also applied to a synthetic image such as an overhead view image, for example. In this case, the captured image or the synthetic image on which the restoration processing is performed may be designated by the operation input portion 20 or automatically selected in response to an image displayed at the display device 16 or image data used for surroundings monitoring, for example.

The surroundings monitoring program for the restoration processing performed by the surroundings monitoring portion 42 (CPU 24a) according to the embodiment may be provided as a file that is installable or executable and that is stored at a recording medium such as a CD-ROM, a flexible disk (FD), a CD-R, and a digital versatile disk (DVD), for example, readable by a computer.

The surroundings monitoring program may be also provided in a manner to be stored on a computer connected to a network such as an internet, for example, and to be downloaded via the network. Further, the surroundings monitoring program performed in the embodiment may be provided or distributed via a network such as an internet, for example.

The embodiment is not limited to include the aforementioned constructions and may be appropriately changed or modified.

According to the disclosure, a surroundings monitoring apparatus includes an image acquisition portion 42b acquiring a captured image captured by an imaging device 14 while a vehicle 10 is moving, the imaging device 14 being mounted at the vehicle 10 to capture an image of surroundings of the vehicle 10, a restoration processing portion 42e generating a restoration image 68 in a case where a stain 60 exists in the captured image, the restoration image 68 being obtained by restoring an area that is hidden by the stain 60 in the captured image to a state being inhibited from having the stain 60, and a display determination portion 42f allowing a display of the restoration image 68 until a non-display condition is satisfied, the non-display condition inhibiting the restoration image 68 from being displayed as an image presently indicating the surroundings of the vehicle 10.

When the non-display condition is satisfied, since then, the display of the restoration image 68 is inhibited. Although the restoration image 68 is tentatively usable, the restoration image 68 is avoidable from being continuously utilized for a long time. The surroundings monitoring apparatus is operated in a state where usability and reliability are well-balanced.

In addition, according to the disclosure, the display determination portion 42f recognizes that the non-display condition is satisfied in one of cases where the stain 60 continuously exists after a vehicle operation that allows a user of the vehicle 10 to get out of the vehicle 10 is performed and where the restoration image 68 is displayed for a predetermined time period after the display of the restoration image 68 is started.

In a case where the stain 60 is kept existing because the user does not clean the imaging device 14 in spite of the fact that the user has an opportunity to get out of the vehicle 10 to clean the imaging device 14, the restoration image 68 is thereafter inhibited from being displayed. Additionally, in a case where the vehicle operation that allows the user to get out of the vehicle 10 is not performed for the predetermined time period after the display of the restoration image 68 is started, the restoration image may be possibly kept displayed for a long time without the cleaning of the imaging device 14. The restoration image 68 is thus inhibited from being displayed when and after the predetermined time period has elapsed from the start of the display of the restoration image 68. The restoration image 68 is restrained from being used for a long time accordingly.

Further, according to the disclosure, the display determination portion 42f determines that the vehicle operation is obtained in a case where at least one of conditions is satisfied, the conditions including a transmission device that is mounted at the vehicle 10 brought to a parking position, a parking brake of the vehicle 10 becoming effective, any door of the vehicle 10 being opened, and a power switch of the vehicle 10 being turned off.

Timing at which the vehicle operation that allows the user to clean the imaging device 14 during a normal vehicle driving is detectable, so that the user may be recommended to clean the imaging device 14 when getting out of the vehicle 10. The user may less feel to get out of the vehicle 10 only for purposes of cleaning the imaging device 14 accordingly.

Further, according to the disclosure, the surroundings monitoring apparatus further includes a notification portion 42g informing the user of an existence of the stain 60 in a case where the restoration processing portion 42e determines that the stain 60 exists in the captured image.

The user may easily recognize that the restoration image 68 is presently displayed and be encouraged to visually confirm surroundings of the vehicle 10.

Further, according to the disclosure, the notification portion 42g performs at least one of a display notification and a non-display notification, the display notification informing the user that the restoration image 68 is presently displayed in a case where the restoration image 68 is displayed, the non-display notification informing the user that the restoration image 68 is not presently displayed in a case where the non-display condition is satisfied.

The user may thus easily recognize whether the presently displayed image is the restoration image 68.

Further, according to the disclosure, the notification portion 42g informs the user for encouraging the user to clean the imaging device 14 when the vehicle operation that allows the user to get out of the vehicle 10 is obtained in a state where the restoration image 68 is displayed.

The user is thus informed of recommendation to clean the imaging device 14 by the vehicle operation performed during the normal vehicle driving. The user may less feel to get out of the vehicle 10 only for purposes of cleaning the imaging device 14 accordingly. In addition, the user may easily recognize that cleaning the imaging device 14 is presently necessary, which reduces the user from forgetting to clean the imaging device 14.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A surroundings monitoring apparatus comprising:
an acquisition portion acquiring a captured image captured by an imaging device while a vehicle is moving, the imaging device being mounted at the vehicle to capture an image of surroundings of the vehicle;
a restoration processing portion generating a restoration image in a case where a stain exists in the captured image, the restoration image being obtained by restoring an area that is hidden by the stain in the captured image to a state being inhibited from having the stain; and
a display determination portion allowing a display of the restoration image until a non-display condition is satisfied, the non-display condition inhibiting the restoration image from being displayed as an image presently indicating the surroundings of the vehicle.

2. The surroundings monitoring apparatus according to claim 1, wherein the display determination portion recognizes that the non-display condition is satisfied in one of cases where the stain continuously exists after a vehicle operation that allows a user of the vehicle to get out of the vehicle is performed and where the restoration image is displayed for a predetermined time period after the display of the restoration image is started.

3. The surroundings monitoring apparatus according to claim 2, wherein the display determination portion determines that the vehicle operation is obtained in a case where at least one of conditions is satisfied, the conditions including a transmission device that is mounted at the vehicle brought to a parking position, a parking brake of the vehicle becoming effective, any door of the vehicle being opened, and a power switch of the vehicle being turned off.

4. The surroundings monitoring apparatus according to claim 1, further comprising a notification portion informing the user of an existence of the stain in a case where the restoration processing portion determines that the stain exists in the captured image.

5. The surroundings monitoring apparatus according to claim 4, wherein the notification portion performs at least one of a display notification and a non-display notification, the display notification informing the user that the restoration image is presently displayed in a case where the restoration image is displayed, the non-display notification informing the user that the restoration image is not presently displayed in a case where the non-display condition is satisfied.

6. The surroundings monitoring apparatus according to claim 4, wherein the notification portion informs the user for encouraging the user to clean the imaging device when the vehicle operation that allows the user to get out of the vehicle is obtained in a state where the restoration image is displayed.

7. The surroundings monitoring apparatus according to claim 2, further comprising a notification portion informing the user of an existence of the stain in a case where the restoration processing portion determines that the stain exists in the captured image.

8. The surroundings monitoring apparatus according to claim 3, further comprising a notification portion informing the user of an existence of the stain in a case where the restoration processing portion determines that the stain exists in the captured image.

9. The surroundings monitoring apparatus according to claim 5, wherein the notification portion informs the user for encouraging the user to clean the imaging device when the vehicle operation that allows the user to get out of the vehicle is obtained in a state where the restoration image is displayed.
